(19) United States
(12) Patent Application Publication
(10) Pub. No.: US 2026/0016602 A1
(43) Pub. Date: Jan. 15, 2026

(54) Frequency Modulated Continuous Wave Optical Authentication System

(71) Applicant: Apple Inc., Cupertino, CA (US)

(72) Inventors: Arun Srivatsan Rangaprasad, San Jose, CA (US); Anselm Grundhoefer, Campbell, CA (US)

(73) Assignee: Apple Inc., Cupertino, CA (US)

(21) Appl. No.: 19/205,518

(22) Filed: May 12, 2025

Related U.S. Application Data
(60) Provisional application No. 63/669,133, filed on Jul. 9, 2024.

(51) Int. Cl. G01S 17/89; G01S 7/48; G01S 7/481; G01S 7/4911; G01S 7/4915; G01S 17/50; G06F 21/32

(52) U.S. Cl. CPC G01S 17/89; G01S 7/4802; G01S 7/4814; G01S 7/4911; G01S 7/4915; G01S 17/50; G06F 21/32

(57) ABSTRACT

An authentication system may use a frequency modulated continuous wave sensor to send and receive a signal towards an eye of a user. The received signal may include information about the structure and material properties of the eye. The authentication system may use the information that is included in the received signal to determine whether the sent signal is directed to an eye, whether the eye is open or closed, and whether the user corresponding to the eye is a particular previous user.

### PRIORITY CLAIM

This application claims benefit of priority to U.S. Provisional Application Ser. No. 63/669,133, entitled “Frequency Modulated Continuous Wave Optical Authentication System,” filed Jul. 9, 2024, which is incorporated herein by reference in its entirety.

### BACKGROUND

### Technical Field

This disclosure relates generally to modeling the eye for use in authenticating a user of a device.

### Description of the Related Art

A head-mounted device may use a camera directed towards a user to perform an authentication process. The authentication process may include obtaining information about the user via the camera, for example, information about a user's iris, and comparing the information to information generated about an authenticated user during an enrollment process.

### SUMMARY

An authentication system may use a frequency modulated continuous wave lidar sensor (FMCW sensor) to obtain structural information about an eye. The FMCW sensor may send a signal with a shaped frequency towards the eye and determine, based on the shaped frequency of a received signal, that the received signal is the sent signal which has been reflected back towards the FMCW sensor. Information included in the received signal may include information about the object that reflected the signal, including information about material properties of the object (e.g., material properties of an eye). The authentication system may use information about the material properties of an eye as identifying information to determine whether the user corresponding to the eye is the same user as a previous user. The authentication system may determine that the user is associated with access credentials, such as for a particular account or payment method.

The authentication system may determine the information about the material properties of the eye by converting the reflected signal to the frequency domain and analyzing the resulting signal. The authentication system may convert the signal to the frequency domain by using a Fourier transform. The reflected signal, in the frequency domain, may include peaks at particular frequencies which may correspond to anatomical features of the eye, such as the eyelid, the sclera, the cornea, the iris, the lens, and the retina.

The height of a peak, which may correspond to the intensity of the reflected signal at the particular frequency, may indicate material properties of the anatomical feature that corresponds to the peak. For example, the height of the peak corresponding to the lens of the eye may be affected by the specific composition of the lens, such as proteins in the lens fibers. The authentication system may be able to identify a user based on the material properties of anatomical structures of the eye. The FMCW sensor may comprise an array of individual FMCW sensors, which may be directed to various portions of the eye. The authentication system may use the aggregate information from the array of FMCW sensors to determine an identity of the user.

Additionally, material properties may include biological indicators. For example, the height of a peak corresponding to the eyelid may be different at different points in time as a result of a user's heartbeat or breathing changing the oxygenation and pressure changes in subcutaneous blood vessels. The authentication system may prevent authentication if the reflected signal does not comprise biological indicators.

The authentication system may further use information from an FMCW sensor to determine whether the FMCW sensor is directed to an eye and whether the user is blinking. The authentication system may arrange information from the FMCW sensor into three-dimensional volumetric data, which may indicate whether an object is present that is the shape of an open eye or a closed eye. The authentication system may determine whether an eye is present to determine a user is not wearing a head-mounted device that includes the FMCW sensor. The authentication system may determine whether a user is blinking to determine whether or not to begin an iris-based authentication process.

The authentication system may detect movement of the eye based on the frequency of the peaks using the Doppler effect. As a result of frequency modulation, the frequency of an emitted signal is increased and decreased. A peak in the frequency domain of a reflected signal which has a particular frequency while the signal frequency is being increased may have a different frequency while the signal frequency is being decreased. The change in frequency may correspond to the speed and direct of the eye movement, if there is eye movement. The FMCW sensor may comprise an array of individual FMCW sensors, which may be directed to various portions of the eye. The authentication system may use the aggregate information from the array of FMCW sensors to determine the direction and speed of the eye motion.

### BRIEF DESCRIPTION OF THE DRAWINGS

FIG. 1A is a side view of an FMCW sensor sending a signal towards an eye and receiving a reflected signal from the eye, according to some embodiments.

FIG. 1B is a graph of the intensity over time of a signal sent from the FMCW sensor towards the eye, according to some embodiments.

FIG. 1C is a graph of the frequency over time of a signal sent from the FMCW sensor towards the eye, according to some embodiments.

FIG. 1D is a graph of the frequency over time of a signal sent from the FMCW sensor towards the eye and the received signal reflected from the eye, according to some embodiments.

FIG. 2A is a side view illustrating anatomical features of an eye, according to some embodiments.

FIG. 2B is a graph of the frequency domain of a signal reflected by the sclera, according to some embodiments.

FIG. 2C is a graph of the frequency domain of a signal reflected by the cornea and internal structures of the eye, according to some embodiments.

FIG. 3A is a side view of an FMCW sensor sending a signal through an unactive liquid crystal polymer, according to some embodiments.

FIG. 3B is a side view of an FMCW sensor sending a signal through an active liquid crystal polymer, according to some embodiments.

FIG. 4A is a point cloud representation of three-dimensional volumetric data of an open eye, according to some embodiments.

FIG. 4B is a point cloud representation of three-dimensional volumetric data of a closed eye, according to some embodiments.

FIG. 4C is a point cloud representation of three-dimensional volumetric data of an object other than an eye, according to some embodiments.

FIG. 5 is a flowchart for a method of authenticating a user with a frequency modulated signal, according to some embodiments.

FIG. 6A is a flowchart for a method of determining structural information about the eye based on the frequency domain information, according to some embodiments.

FIG. 6B is a flowchart for a method of determining whether a user is wearing a head-mounted device that includes the FMCW sensor and whether the eye of the user is open or closed, according to some embodiments.

FIG. 7A is a side view of a headset-type head-mounted device, according to some embodiments.

FIG. 7B is a front view of a headset-type head-mounted device, according to some embodiments.

FIG. 7C a back view of a headset-type head-mounted device, according to some embodiments.

FIG. 7D a front view of a glasses-type head-mounted device, according to some embodiments.

FIG. 7E a back view of a glasses-type head-mounted device, according to some embodiments.

FIG. 8 is a block diagram illustrating an example computing device that may be used, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

An authentication system may use a frequency modulated continuous wave sensor (FMCW sensor) to obtain information about an eye that the authentication system may use to authenticate the user corresponding to the eye. The information may include structural information about the eye that the authentication system may determine based on the frequency modulated signal reflected from the eye. The authentication system may analyze the reflected signal to determine surface structural information about the exterior of the user's eye and skin surrounding the eye, and internal structural information about the anatomical features internal to the user's eye. The authentication system may compare information about the eye of the user to information about one or more eyes of previous users. The authentication system may identify the user as a particular previous user. The authentication system may authenticate the user based on the identification of the user as the previous user.

The authentication system may additionally determine other information based on the reflected signal, such as the presence or absence of biological indications and motion of the eye relative to the FMCW sensor. The authentication system may determine, based on an absence of biological indications or an absence of motion, that the object being analyzed is not an eye corresponding to a user. The authentication system may prevent authentication if the authentication system determines the object being analyzed is not an eye belonging to a user.

The authentication system may receive the reflected signal from the FMCW sensor in the form of information indicating the intensity over time of the reflected signal. The authentication system may convert the reflected signal into the frequency domain. In some embodiments, the authentication system may use a Fourier transformation to convert the reflected signal to the frequency domain. The authentication system may obtain structural information about the eye from the reflected signal in the frequency domain. The authentication system may create embeddings based on the structural information, for example, the authentication system may create multi-dimensional vectors which represent particular information about the eye as particular dimensions. The authentication system may generate a similarity score between an embedding based on the eye and an embeddings based on a previously analyzed eye. The authentication system may generate a respective similarity score between the embedding and each respective embedding of a previously analyzed eye that the authentication system is able to access. The authentication system may generate a respective similarity score between the embedding and a portion of the respective embeddings of previously analyzed eyes, for example, right eyes or left eyes. If a similarity score is above a threshold, the authentication system may determine the eye and the previously analyzed eye that corresponds to the embedding that was used to generate the similarity score with the embedding of the eye are the same eye. The authentication system may determine the user is the same user as the previous user corresponding to the previously analyzed eye. If no similarity score is above a threshold, the authentication system may determine the eye corresponds to a new user.

The authentication system may additionally use the structural information to determine whether a head-mounted device comprising the FMCW sensor is being worn or is not being worn by the user, and whether the eye the FMCW sensor is directed to is open or closed. For example, the authentication system may determine that the structural information, when analyzed as three-dimensional volumetric data, is not in the shape of an eye, and the authentication system may conclude the user is not wearing a head-mounted device comprising the FMCW sensor. As another example, the authentication system may determine that the structural information is currently composed of only surface structural information and that internal structural information is absent, and the authentication system may determine that the eye is closed based on the absence of internal structural information and the shape of the surface structural information. The eyelid may be impermeable to the signal emitted by the FMCW sensor, so a reflected signal from the eyelid may comprise surface structural information in the shape of a closed eye and may lack internal structural information. The authentication system may use a trained machine learning model to determine whether three-dimensional volumetric data generated based on analysis of one or more frequency modulated reflected signals is in the shape of an eye.

The FMCW sensor may be a lidar sensor. The FMCW sensor may emit a signal in a range of invisible or near-invisible light frequencies, for example, infrared light or near-infrared light. The FMCW sensor may include a beam splitting component so that the authentication system may additionally receive a portion of an emitted signal to compare to the reflected signal. The authentication system may use the emitted signal obtained by use of the beam splitter in the FMCW sensor to determine the time-of-flight of the reflected signal, which may indicate the distance of the eye and particular features of the eye from the sensor. The authentication system may also use the emitted signal to selectively ignore noise, which may be light signals which do not have the shaped frequency of the emitted signal. The FMCW sensor may modulate the frequency of the emitted signal to have a recognizable shape that may be compared to other signals. The FMCW sensor, while referred to singularly, may be an array of individual FMCW sensors which may be directed to various portions of an eye.

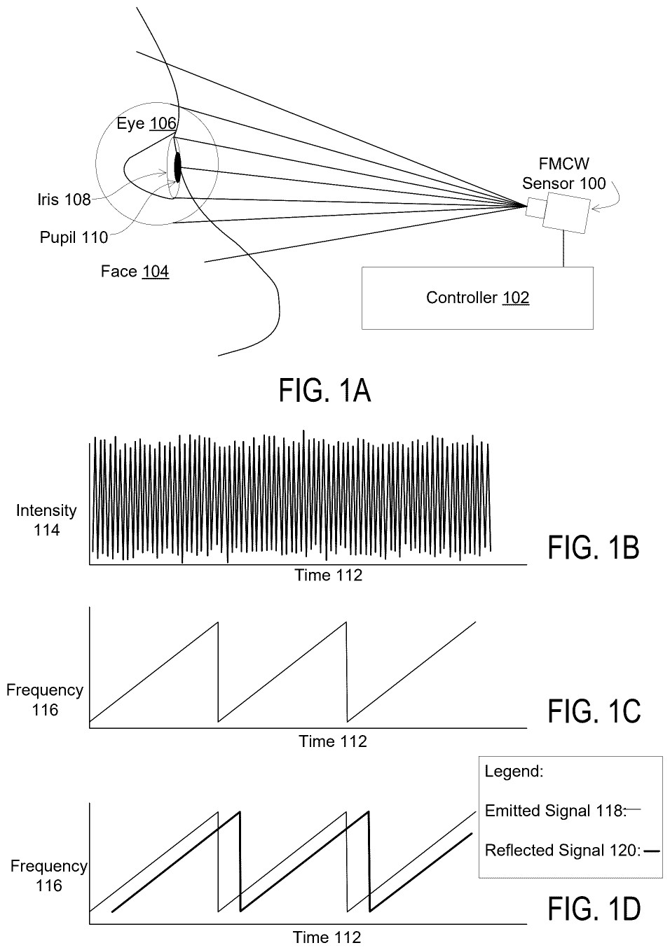

FIG. 1A is a side view of an FMCW sensor sending a signal towards an eye and receiving a reflected signal from the eye, according to some embodiments.

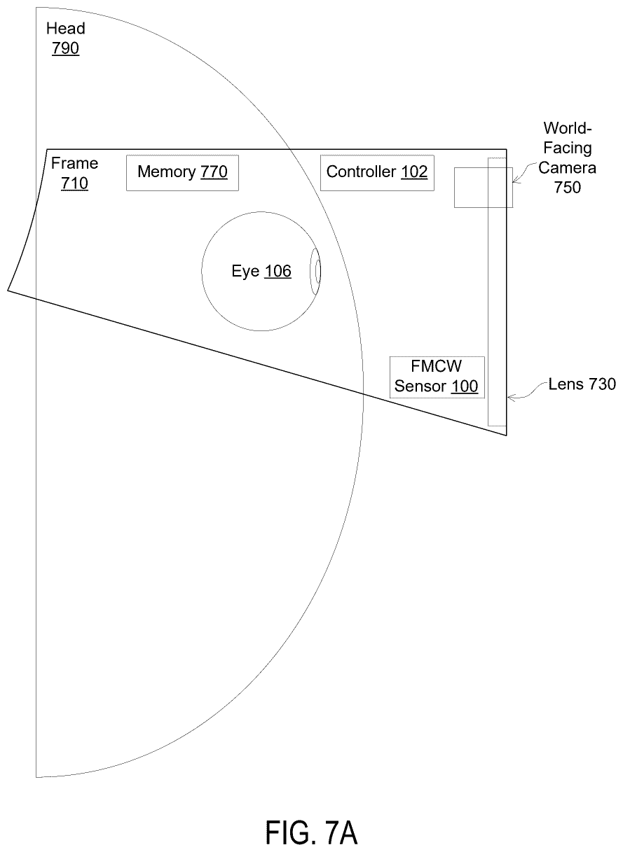

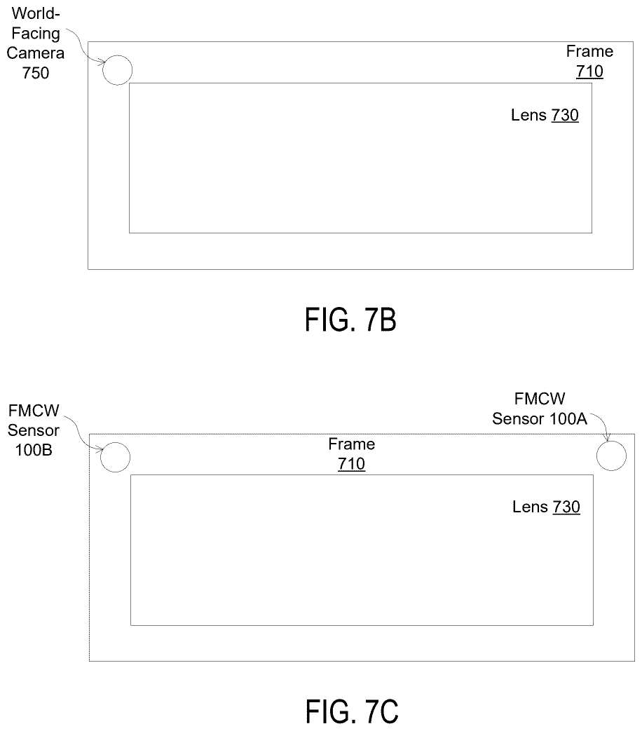

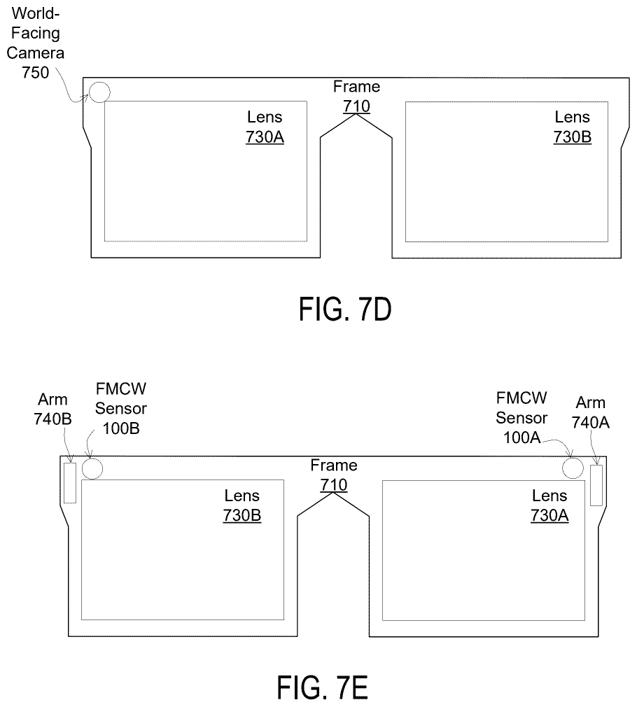

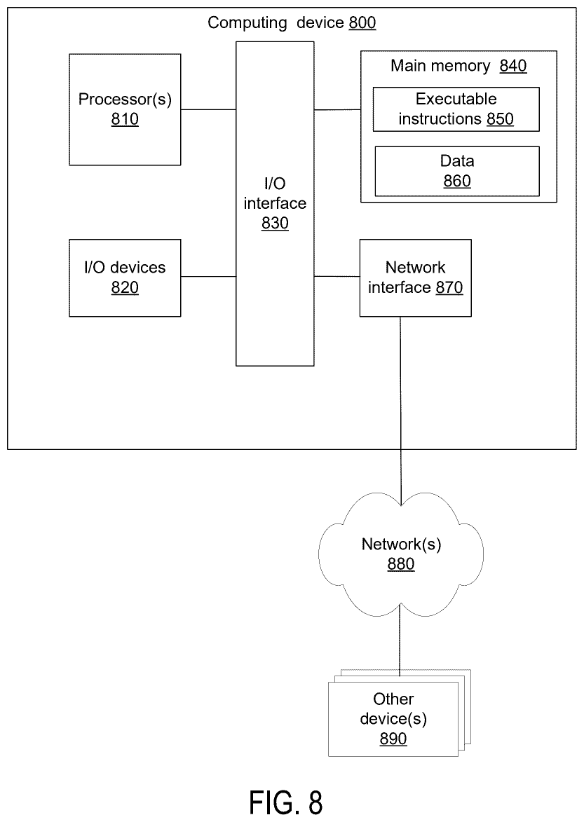

The FMCW sensor 100 may be directed towards an eye 106 to emit signals towards the eye 106 and receive reflected signals from the eye 106. The controller 102, which may be a computing device such as computing device 800 shown in FIG. 8, may cause the FMCW sensor 100 to emit a signal towards the eye 106. The controller may also receive information from the FMCW sensor 100, such as a signal that represents the reflected signal the FMCW sensor 100 received from the eye 106. The FMCW sensor 100 and the controller 102 may be included in a head-mounted device, such as the head-mounted devices illustrated in FIGS. 7A-7E.

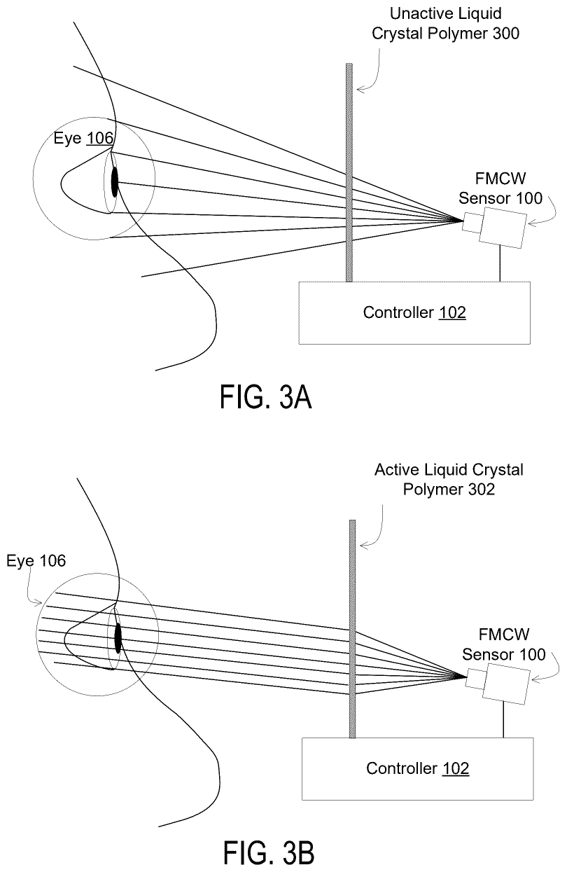

The FMCW sensor 100, which may comprise an array of individual FMCW sensors, may emit signals towards the eye 106 that are reflected by features other than the eye 106, such as the face 104. In some embodiments, the controller 102 may direct the FMCW sensor 100 or another element, such as a liquid crystal polymer, to cause more of the signals emitted by the FMCW sensor 100 to be directed towards the eye 106. An example of the controller 102 directing signals emitted by the FMCW sensor 100 with a liquid crystal polymer is shown in FIGS. 3A-3B.

The signal emitted by the FMCW sensor 100 may interact with the iris 108 and pupil 110 of the eye 106. The signal may be a signal of invisible light, for example, infrared light, so the user may not observe the interaction between the signal and the pupil 110. The iris 108 and pupil 110 may be partially permeable as to the signal, and the signal may further interact with internal anatomical features of the eye 106.

FIG. 1B is a graph of the intensity over time of a signal sent from the FMCW sensor towards the eye, according to some embodiments.

The FMCW sensor 100 may emit a signal towards the eye 106 that has a range of intensity 114 across a period of time 112, as shown in FIG. 1B. The FMCW sensor 100 may measure a reflected signal from the eye 106 according to the intensity 114 over time 112 of the reflected signal. A controller 102 may determine the frequency 116 of the reflected signal, based on the intensity 114 over time 112 measurement of the reflected signal that the FMCW sensor 100 may perform.

FIG. 1C is a graph of the frequency over time of a signal sent from the FMCW sensor towards the eye, according to some embodiments.

The FMCW sensor 100 may emit a signal towards the eye 106 that has a shaped frequency 116 across a period of time 112, as shown in FIG. 1C. The controller 102 may direct the FMCW sensor 100 to modulate the frequency 116 of the signal across time 112. The controller 102 may direct different particular FMCW sensors of an array to modulate the frequency 116 of the signal across time 112 differently from other particular FMCW sensors of an array. For example, one FMCW sensor of an array may emit a signal using a sawtooth harmonic waveform pattern, as illustrated in FIG. 1C, and another FMCW sensor of the array may emit a signal using a triangle harmonic waveform pattern, or another waveform pattern.

FIG. 1D is a graph of the frequency over time of a signal sent from the FMCW sensor towards the eye and the received signal reflected from the eye, according to some embodiments.

The controller 102 may determine the frequency of the reflected signal 120 based on measurement of the reflected signal 120 by the FMCW sensor 100. The FMCW sensor 100 may include a beam splitter, which may provide an emitted signal 118 that the FMCW sensor 100 may also measure to provide to the controller 102 for comparison to the reflected signal 120. The controller 102 may selectively ignore signals which do not have the frequency shape of the emitted signal 118, and thus are not the reflected signal 120.

The FMCW sensor 100 may be operated in environments with an uncontrolled amount of light as a result of the controller 102 using the emitted signal 118 to filter received information for the reflected signal 120. Additionally, the controller 102 may use the time 112 that elapses between the emitted signal 118 and the reflected signal 120, i.e., the horizontal distance between the signals on the graph illustrated in FIG. 1D, to determine the time-of-flight of the signal from being emitted by the FMCW sensor 100 to being measured by the FMCW sensor 100. The time-of-flight may be an indication of the distance from the reflecting surface, which may be anatomical features of the eye 106, to the FMCW sensor 100. The controller 102 may determine structural information, such as three-dimensional volumetric data, based on the depth information determined based on the time-of-flight.

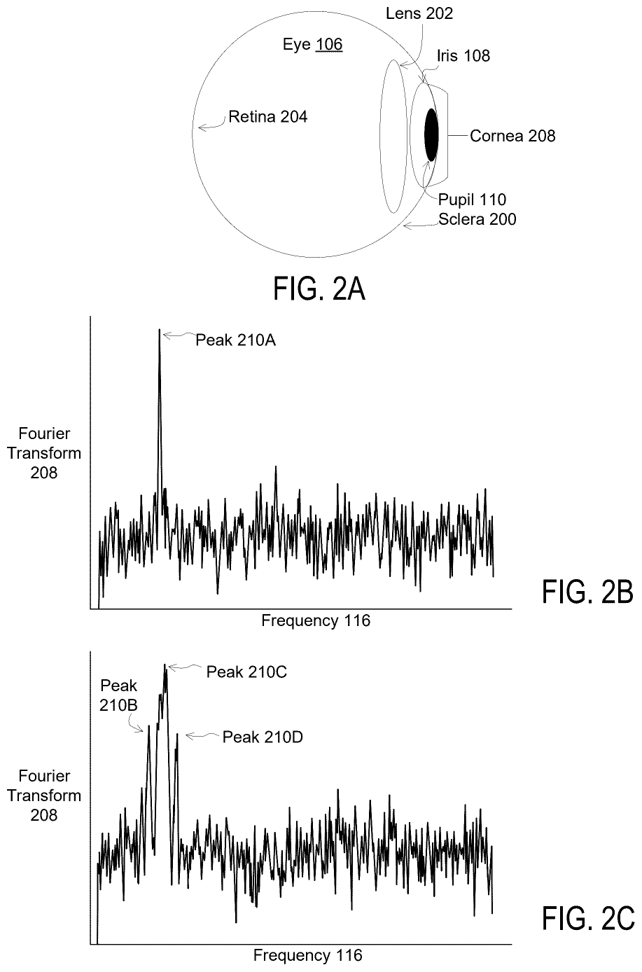

FIG. 2A is a side view illustrating anatomical features of an eye, according to some embodiments.

The signal emitted by an FMCW sensor may be reflected by anatomical features of the eye 106, may permeate anatomical features of the eye 106, or may be partially reflected by an anatomical feature and partially permeate the anatomical feature. For example, the sclera 200, the retina 204, and skin may be impermeable to the signal and may entirely reflect the signal. As another example, the pupil 110 may not reflect the signal and may be entirely permeable to the signal. As another example, the iris 108, lens 202, and cornea 208 may partially reflect the signal and may be partially permeable to the signal. The cornea 208 may externally cover the iris 108 and the pupil 110.

The authentication system may obtain structural information about the eye 106 based on the anatomical features of the eye 106 reflecting the signal. The authentication system may obtain surface structural information from a signal reflected by an external feature of the eye 106, which may be permeable or impermeable to the signal. For example, the reflected signal may include surface structural information when the signal is reflected by the sclera 200, the cornea 208, the eyelid, or skin surrounding the eye 106. The authentication system may obtain internal structural information when the signal at least partially passes through a permeable or semi-permeable external feature of the eye 106, such as the cornea 208, and is reflected or partially reflected by an internal feature of the eye 106, such as the iris 108, the lens 202, or the retina 204.

FIG. 2B is a graph of the frequency domain of a signal reflected by the sclera, according to some embodiments.

The controller may convert the reflected signal into the frequency domain. For example, the controller may apply a Fourier transform 208 to the signal so that the signal can be analyzed according to frequency 116. As illustrated in FIG. 2B, the signal in the frequency domain may have a single peak 210A that is above a threshold (not illustrated in FIG. 2B). A single peak 210 above a threshold in the frequency domain may indicate that an impermeable external surface reflected the signal. For example, the signal in the frequency domain as illustrated in FIG. 2B may have been reflected by the sclera 100. The authentication system may use the height and frequency 116 of peak 210A to determine information about the surface that reflected the signal. For example, the sclera 200 and an eyelid may be associated with different expected frequency ranges of a peak 210A, and the authentication system may determine that the sclera 200 reflected the signal based on the frequency of peak 210A. As another example, changes in the height of a peak 210A corresponding to skin surrounding the eye 106 may be a biological indicator, because the skin surrounding the eye 106 may reflect light differently depending on activity of the circulatory system of a user. A change in the height of a peak 210A as determined at different times may be a biological indicator. The authentication system may determine motion of the skin or sclera relative to the FMCW sensor based on the frequency of peak 210A according to the Doppler effect.

FIG. 2C is a graph of the frequency domain of a signal reflected by the cornea and internal structures of the eye, according to some embodiments.

The controller may convert the reflected signal into the frequency domain. For example, the controller may apply a Fourier transform 208 to the signal so that the signal can be analyzed according to frequency 116. As illustrated in FIG. 2C, the signal in the frequency domain may have multiple peaks 210, such as peak 210B, peak 210C, and peak 210D, above a threshold (not illustrated in FIG. 2C. A signal in the frequency domain may have multiple peaks 210 as a result of the reflected signal being reflected by internal eye structures (i.e., the iris 108, the lens 202, and the retina 204) after passing through an external eye structure (i.e., the cornea 206).

Different peaks 210 may correspond to different eye structures, for example, peak 210B may correspond to the cornea 206, peak 210C may correspond to the lens 202, and peak 210D may correspond to the retina 204. Lower frequency peaks 210 may correspond to more external structures than higher frequency peaks 210. The authentication system may determine information about the internal eye structures based on the height of the peaks 210 and the frequencies of the peaks 210. For example, the authentication system may use the heights of specific ones of the peaks 210 as identifying information for authenticating the user. The heights of peaks 210 may be affected by material properties of the eye, which may vary from user to user. For example, a particular user may have a high amount of a particular protein located in the cornea 206, which may cause the peak 210B corresponding to the cornea 206 to be higher than a user having a cornea 206 with a normal amount of the protein. The resting or average frequency of a peak 210 corresponding to a particular anatomical feature may also be identifying information.

FIG. 3A is a side view of an FMCW sensor sending a signal through an unactive liquid crystal polymer, according to some embodiments.

In some embodiments, a controller 102 may use a liquid crystal polymer to direct signals emitted by a FMCW sensor 100 towards an eye and the reflected signals from the eye. Unactive liquid crystal polymer 300 may not change the direction of the signals. Liquid crystal polymer may be unactive liquid crystal polymer 300 when the controller 102 is not sending electrical signals through the liquid crystal polymer.

FIG. 3B is a side view of an FMCW sensor sending a signal through an active liquid crystal polymer, according to some embodiments.

Liquid crystal polymer may be active liquid crystal polymer 302 when the controller is sending electrical signals through the liquid crystal polymer. Active liquid crystal polymer may direct signals from the FMCW sensor 100 to the eye 106 and back to the FMCW sensor 100 from the eye 106. The controller 102 may activate the liquid crystal polymer based on a determination that the FMCW sensor 100 is partially directed toward an eye 106, and that the active liquid crystal polymer 302 can increase the number of signals generated by an FMCW sensor 100 (which may be an array of individual FMCW sensors) that are directed towards the eye 106.

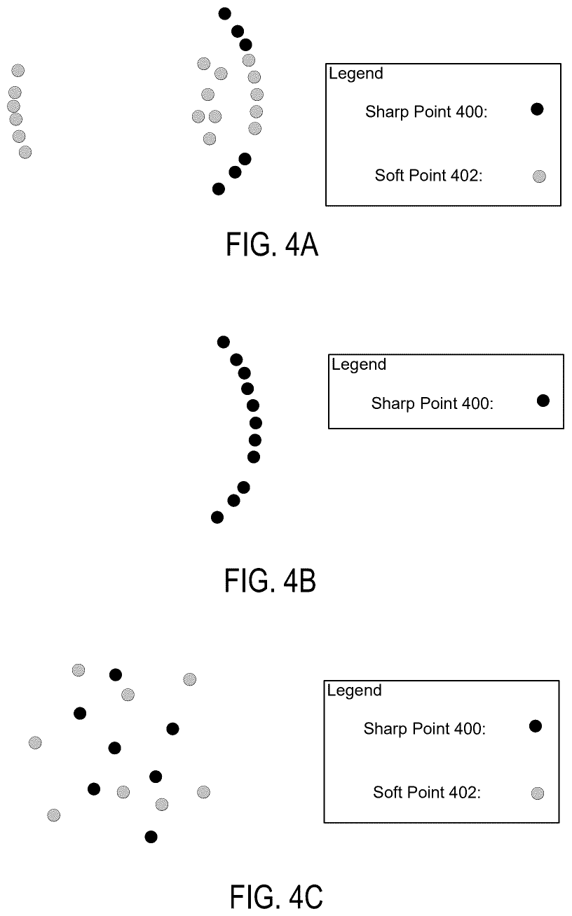

FIG. 4A is a point cloud representation of three-dimensional volumetric data of an open eye, according to some embodiments.

The authentication system may generate three-dimensional volumetric data based on the time-of-flight information and the structural information. For example, FIGS. 4A-4C are point cloud representations that may be generated by an authentication system. Each point may be associated with information, for example, the height and frequency of a peak 210 in a frequency domain graph that is associated with the point. The three-dimensional volumetric data may be data which the authentication system may use as identifying data.

The black dots are sharp points 400, which may be points that are associated with a reflected signal that was reflected by a signal impermeable structure, such as the sclera or skin. The peak 210 A of the signal illustrated in FIG. 2B may be associated with a sharp point 400. The grey dots are soft points 402, which may be points that are associated with a reflected signal that partially permeated an external structure of the eye (i.e., the cornea). The peaks 210B, 201C, and 210D of FIG. 2C may be soft peaks 402.

The three-dimensional volumetric data may match the expected general structure of external and internal features of an eye, as illustrated in FIG. 4A. The authentication system may determine, based on the three-dimensional volumetric data, that the FMCW sensor is directed towards an eye and that the eye is open. The fact that the eye is open may be a blink state of the eye. The authentication system may use a trained machine learning model to analyze the three-dimensional volumetric data to determine whether an eye is present or partially present, and whether the eye is open or closed.

FIG. 4B is a point cloud representation of three-dimensional volumetric data of a closed eye, according to some embodiments.

A closed eye, covered by an eyelid, may non-permeably reflect the signals emitted by an FMCW sensor. The authentication system may generate three-dimensional volumetric data with only sharp point 400 based on the reflected signals. The authentication system may generate three-dimensional volumetric data corresponding to a closed eye as illustrated in FIG. 4B, and may determine, based on the three-dimensional volumetric data, that the eye is closed. The fact that the eye is closed may be a blink state of the eye. The authentication system may prevent an attempt to perform iris-based authentication based on the eye having a closed blink state, which may conserve computing resources that would otherwise be spent on an iris-based authentication that is likely to be inconclusive.

The authentication system may attempt authentication based on frequency modulated signals reflected from a closed eye. The information the authentication system obtains from the reflected signal in the frequency domain may be identifying information that the authentication system may use to generate a similarity score between the user and one or more previous users. Surface structural information, such as information about material properties of the eyelid which may influence the height of a peak of a sharp point 400 for example, may be usable identifying information. As another example, motion of the eyelid over a period of time may be identifying information. Individual users may have unique patterns of skin motion and skin deformation, for example, as a result of variations in subcutaneous muscle structures and properties of skin such as elasticity. The authentication system may determine motion of the eyelid and skin surrounding the eye by comparing the frequencies of a particular sharp point 400 during periods of time when the frequency of the signal is increasing and periods of time when the frequency of the signal is decreasing, or by comparing the frequencies of peaks to a motionless or average frequency.

FIG. 4C is a point cloud representation of three-dimensional volumetric data of an object other than an eye, according to some embodiments.

The authentication system may generate three-dimensional volumetric data that does not resemble an eye, as illustrated in FIG. 4C. The three-dimensional volumetric data may have sharp points 400 and soft points 402 that do not match the expected structure of an open or closed eye. The authentication system may determine, based on the three-dimensional volumetric data, that the FMCW sensor is not directed towards an eye.

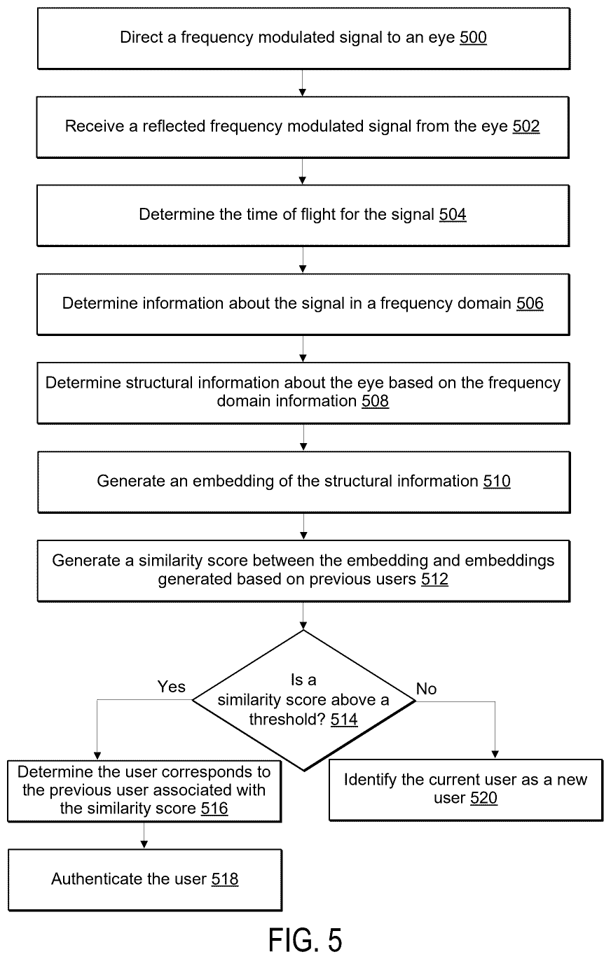

FIG. 5 is a flowchart for a method of authenticating a user with a frequency modulated signal, according to some embodiments.

At 500, the authentication system may direct a frequency modulated signal to an eye. The authentication system may use an FMCW sensor to emit a signal (e.g., an infrared light signal) towards the eye in a shaped frequency pattern. The eye may reflect the signal back towards the FMCW sensor and preserve the shaped frequency pattern.

At 502, the authentication system may receive a reflected frequency modulated signal from the eye. The reflected signal may contain structural information about the eye. At 504, the authentication system may determine the time-of-flight for the signal. The authentication system may also determine depth information based on the time-of-flight. At 506, the authentication system may determine information about the reflected signal in a frequency domain. The authentication system may use a Fourier transform to analyze the reflected signal in the frequency domain. The information about the signal may include the particular structures of the eye that reflected the signal, motion of the eye, and material properties of the structures that reflected the signal.

At 508, the authentication system may determine structural information about the eye based on the frequency domain information. The structural information may include three-dimensional volumetric data the authentication system may generate by correlating peaks of a frequency domain graph with the time-of-flight information.

At 510, the authentication system may generate an embedding of the structural information. The embedding may be a multi-dimensional vector which includes information that may be used to identify a user, such as information based on material properties of anatomical features of the eye, i.e., the heights of peaks of a reflected signal in the frequency domain which correspond to anatomical features of the eye. The authentication system may use a trained machine learning model to generate the embedding. At 512, the authentication system may generate a similarity score between the embedding and embeddings generated based on previous users. The authentication system may calculate a similarity score based on a distance between multi-dimensional vectors generated based on the eye and an eye of a previous user.

At 514, the authentication system may determine whether any of the similarity scores generated between the embedding and the embeddings generated based on previous users is above a threshold. If a similarity score is above the threshold, at 516 the authentication system may determine the user corresponds to the previous user associated with the similarity score. Further, at 518, the authentication system may authenticate the user. For example, the authentication system may determine the previous user is associated with an account and provide the authenticated user with access to the account. If no similarity score is above a threshold, at 520 the authentication system may identify the current user as a new user.

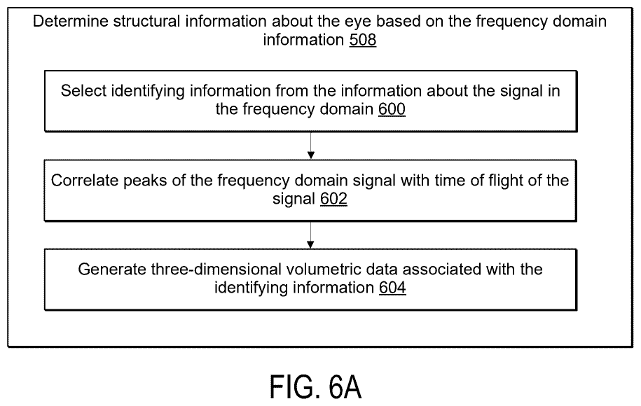

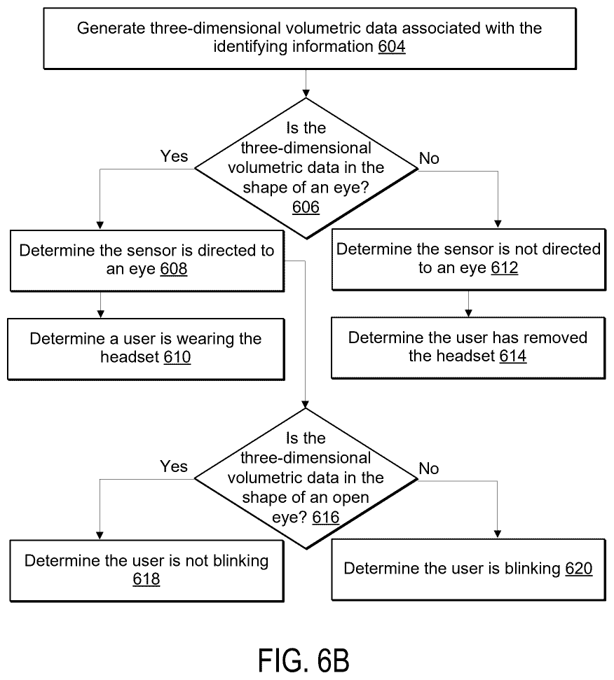

FIG. 6A is a flowchart for a method of determining structural information about the eye based on the frequency domain information, according to some embodiments.

In order to determine structural information about the eye based on the frequency domain information, the authentication system may perform additional steps. At 600, the authentication system may select identifying information from the information about the signal in the frequency domain. For example, the authentication system may identify local peaks of a frequency domain graph of a reflected signal that are above a threshold and identify the height and frequency of the peaks. At 602, the authentication system may correlate peaks of the frequency domain signal with time-of-flight of the signal. At 604, the authentication system may generate three-dimensional volumetric data associated with the identifying information. The three-dimensional volumetric data may, for example, be a point cloud representation of the data.

FIG. 6B is a flowchart for a method of determining whether a user is wearing a head-mounted device that includes the FMCW sensor and whether the eye of the user is open or closed, according to some embodiments.

At 604, the authentication system may generate three-dimensional volumetric data associated with the identifying information. At 606, the authentication system may determine whether the three-dimensional volumetric data is in the shape of an eye. The authentication system may use a trained machine learning model to determine whether the three-dimensional volumetric data is in the shape of an eye. If the authentication system determines the three-dimensional volumetric data is in the shape of an eye, at 608 the authentication system may determine the sensor is directed to an eye. Further, at 610, the authentication system may determine a user is wearing a head-mounted device comprising the FMCW sensor. If the authentication system determines the three-dimensional volumetric data is not in the shape of an eye, at 612, the authentication system may determine the sensor is not directed to an eye. Further, at 614, the authentication system may determine the user has removed the head-mounted device.

In response to the authentication system determining the sensor is directed to an eye, at 616 the authentication system may determine whether the three-dimensional volumetric data is in the shape of an open eye. The authentication system may use a trained machine learning model to determine whether the three-dimensional volumetric data is in the shape of an open eye. If the authentication system determines the three-dimensional volumetric data is in the shape of an open eye, at 618 the authentication system may determine the user is not blinking. If the authentication system determines the three-dimensional volumetric data is not in the shape of an open eye, at 620 the authentication system may determine the user is blinking.

FIGS. 7A-E illustrate example devices in which the methods of FIGS. 1 through 6B may be implemented, according to some embodiments. Note that the devices as illustrated in FIGS. 7A through 7E are given by way of example and are not intended to be limiting. In various embodiments, the shape, size, and other features of an HMD may differ, as may the locations, numbers, types, and other features of the components of an HMD and of the eye imaging system. FIG. 7A shows a side view of an example HMD, and FIGS. 7B and 7D show alternative front views of example HMDs, with FIG. 7B showing a device that has one lens 730 that covers both eyes 740 and FIG. 7D showing a device that has right 730A and left 730B lenses. FIGS. 7C and 7E show respective back views of the HMDs of FIGS. 7B and 7D.

FIG. 7A is a side view of a headset-type head-mounted device, according to some embodiments.

FIG. 7A illustrates an example head-mounted device (HMD) that may include components and implement methods as illustrated in FIGS. 1 through 6B, according to some embodiments. As shown in FIG. 7A, the HMD may be positioned on the user's head 790 such that the display is disposed in front of the user's eyes. The user looks through the eyepieces onto the display.

The HMD may include lens(es) 730, mounted in a wearable housing or frame 710. The HMD may be worn on a user's (the “wearer”) head so that the lens(es) is disposed in front of the wearer's eyes 106. In some embodiments, an HMD may implement any of various types of display technologies or display systems. For example, the HMD may include a display system that directs light that forms images (virtual content) through one or more layers of waveguides in the lens(es) 730; output couplers of the waveguides (e.g., relief gratings or volume holography) may output the light towards the wearer to form images at or near the wearer's eyes 106.

As another example, the HMD may include a direct retinal projector system that directs light towards reflective components of the lens(es); the reflective lens(es) is configured to redirect the light to form images at the wearer's eyes 106. In some embodiments the display system may change what is displayed to at least partially affect the conditions and features of the eye 106. For example, the display may increase the brightness to change the conditions of the eye 106 such as lighting that is affecting the eye 106. Another example, the display may change the distance an object appears on the display to affect the conditions of the eye 106 such as the accommodation distance of the eye 106.

In some embodiments, HMD may also include one or more sensors that collect information about the wearer's environment (video, depth information, lighting information, etc.) and about the wearer (e.g., eye or gaze sensors). The sensors may include one or more of, but are not limited to one or more eye cameras (e.g., infrared (IR) cameras) that capture views of the user's eyes 106, one or more world-facing or PoV cameras 750 (e.g., RGB video cameras) that can capture images or video of the real-world environment in a field of view in front of the user, and one or more ambient light sensors that capture lighting information for the environment. Cameras 750 and FMCW sensors 100 may be integrated in or attached to the frame 710. The HMD may also include one or more illumination sources such as LED or infrared point light sources that emit light (e.g., light in the IR portion of the spectrum) towards the user's eye or eyes 106.

A controller 102 for an authentication system may be implemented in the HMD, or alternatively may be implemented at least in part by an external device (e.g., a computing system or handheld device) that is communicatively coupled to the HMD via a wired or wireless interface. Controller 102 may include one or more of various types of processors, image signal processors (ISPs), graphics processing units (GPUs), coder/decoders (codecs), system on a chip (SOC), CPUs, and/or other components for processing and rendering video and/or images.

Memory 770 for an authentication system may be implemented in the HMD, or alternatively may be implemented at least in part by an external device (e.g., a computing system) that is communicatively coupled to the HMD via a wired or wireless interface. The memory 770 may, for example, be used to record video or images captured by the one or more cameras 750 integrated in or attached to frame 710. Memory 770 may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc.

In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

While FIG. 7A only shows an FMCW sensor 100 for one eye, embodiments may include FMCW sensor 100 for each eye, and user authentication may be performed for both eyes. In addition, the FMCW sensor 100 may be located elsewhere than shown. An HMD can have an opaque display, or can use a see-through display, which allows the user to see the real environment through the display, while displaying virtual content overlaid on the real environment.

FIG. 7B is a front view of a headset-type head-mounted device, according to some embodiments.

A headset-type head-mounted device may include a lens 730 set into a frame 710. The front of a headset-type head-mounted device may include a world-facing camera 750, which the device may use for various applications which rely on the device having access to the view a user may see through the lens 730 of the device.

FIG. 7C a back view of a headset-type head-mounted device, according to some embodiments.

The back of a headset-type head-mounted device may be how the device appears to the user while the user is wearing the headset-type head-mounted device. The headset-type head-mounted device may include FMCW sensor 100A, which may be directed to the user's right eye, and FMCW sensor 100B, which may be directed to the user's left eye. The FMCW sensors 100 may be set into the frame 710 of the headset-type head-mounted device. The user may view the environment through lens 730 or may view images displayed on lens 730.

FIG. 7D a front view of a glasses-type head-mounted device, according to some embodiments.

A glasses-type head-mounted device may include lens 730A and lens 730B set into a frame 710. The front of a glasses-type head-mounted device may include a world-facing camera 750, which the device may use for various applications which rely on the device having access to the view a user may see through the lenses 730 of the device.

FIG. 7E a back view of a glasses-type head-mounted device, according to some embodiments.

The back of a glasses-type head-mounted device may be how the device appears to the user while the user is wearing the glasses-type head-mounted device. The glasses-type head-mounted device may include FMCW sensor 100A, which may be directed to the user's right eye, and FMCW sensor 100B, which may be directed to the user's left eye. The FMCW sensors 100 may be set into the frame 710 of the glasses-type head-mounted device. The user may view the environment through lenses 730 or may view images displayed on lenses 730. The glasses-type display device may include arms 740 attached to the frame 710 to keep the glasses-type display device in place.

FIG. 8 is a block diagram illustrating an example computing device that may be used, according to some embodiments.

In at least some embodiments, a computing device that implements a portion or all of one or more of the techniques described herein may include a general-purpose computer system that includes or is configured to access one or more computer-accessible media. FIG. 8 illustrates such a general-purpose computing device 800. In the illustrated embodiment, computing device 800 includes one or more processors 810 coupled to a main memory 840 (which may comprise both non-volatile and volatile memory modules and may also be referred to as system memory) via an input/output (I/O) interface 830. Computing device 800 further includes a network interface 870 coupled to I/O interface 830, as well as additional I/O devices 820 which may include sensors of various types.

In various embodiments, computing device 800 may be a uniprocessor system including one processor 810, or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA. In some implementations, graphics processing units (GPUs) may be used instead of, or in addition to, conventional processors.

Memory 840 may be configured to store instructions and data accessible by processor(s) 810. In at least some embodiments, the memory 840 may comprise both volatile and non-volatile portions; in other embodiments, only volatile memory may be used. In various embodiments, the volatile portion of system memory 840 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, executable program instructions 850 and data 860 implementing one or more desired functions, such as those methods, techniques, and data described above, are shown stored within main memory 840.

In one embodiment, I/O interface 830 may be configured to coordinate I/O traffic between processor 810, main memory 840, and various peripheral devices, including network interface 870 or other peripheral interfaces such as various types of persistent and/or volatile storage devices, sensor devices, etc. In some embodiments, I/O interface 830 may perform any necessary protocol, timing, or other data transformations to convert data signals from one component (e.g., main memory 840) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to memory 840, may be incorporated directly into processor 810.

Network interface 870 may be configured to allow data to be exchanged between computing device 800 and other devices 890 attached to a network or networks 880, such as other computer systems or devices. In various embodiments, network interface 870 may support communication via any suitable wired or wireless general data networks, such as types of Ethernet network, for example. Additionally, network interface 870 may support communication via telecommunications/telephony networks such as analog voice networks or digital fiber communications networks, via storage area networks such as Fibre Channel SANs, or via any other suitable type of network and/or protocol.

In some embodiments, main memory 840 may be one embodiment of a computer-accessible medium configured to store program instructions and data as described above for FIG. 1 through FIG. 7E for implementing embodiments of the corresponding methods and apparatus. However, in other embodiments, program instructions and/or data may be received, sent, or stored upon different types of computer-accessible media. Generally speaking, a computer-accessible medium may include non-transitory storage media or memory media such as magnetic or optical media, e.g., disk or DVD/CD coupled to computing device 800 via I/O interface 830. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 800 as main memory 840 or another type of memory. Further, a computer-accessible medium may include transmission media or signals such as electrical, electromagnetic, or digital signals, conveyed via a communication medium such as a network and/or a wireless link, such as may be implemented via network interface 870. Portions or all of multiple computing devices such as that illustrated in FIG. 8 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a frequency modulated continuous wave (FMCW) sensor configured to be directed to an eye, wherein the FMCW sensor is configured to emit a signal and receive a reflected signal;
a controller, configured to:
determine structural information of the eye based on the reflected signal, wherein the structural information comprises surface structural information and internal structural information;
determine, based on the structural information, that a user corresponding to the eye corresponds to a previous user; and
authenticate the user based on the determination that the user corresponds to the previous user.

2. The system of claim 1, further comprising:
a liquid crystal polymer configured to be disposed between the FMCW sensor and the eye, wherein the controller is further configured to control the liquid crystal polymer.

3. The system of claim 1, wherein the reflected signal comprises a first frequency profile and a second frequency profile, wherein the controller is further configured to:
determine the surface structural information based on the first frequency profile; and
determine the internal structural information based on the second frequency profile.

4. The system of claim 3, wherein the controller is further configured to determine the first frequency profile and the second frequency profile by converting the reflected signal to the frequency domain.

5. The system of claim 1, wherein the reflected signal comprises information about material properties of the eye.

6. The system of claim 1, wherein the reflected signal comprises information about motion of the eye.

7. The system of claim 1, wherein to determine the user corresponds to the previous user, the controller is further configured to:
generate one or more embeddings based on the reflected signal;
generate a similarity score between the one or more embeddings based on the reflected signal and one or more embeddings based on the previous user; and
determine the similarity score is above an authentication threshold.

8. The system of claim 1, wherein the controller is further configured to:
determine, based on the reflected signal, whether the reflected signal comprises one or more biometric indicators; and
prevent authentication in response to a determination that the reflected signal does not comprise the one or more biometric indicators.

9. The system of claim 1, wherein the controller is further configured to:
determine, based on the surface structural information, a blink state of the eye; and
determine, based on the blink state of the eye and the determination that the user corresponds to the previous user, whether to initiate iris-based authentication.

10. The system of claim 1, wherein the controller is further configured to:
determine, based on the reflected signal, motion of skin; and
determine, based on the motion of the skin, that the user corresponds to a previous user.

11. The system of claim 1, wherein the FMCW sensor and the controller are included in a head-mounted device.

12. A method, comprising:
receiving a reflected signal, reflected from an eye, of a signal from a frequency modulated continuous wave (FMCW) sensor directed to the eye;
determining structural information of the eye based on the reflected signal, wherein the structural information comprises surface structural information and internal structural information;
determining, based on the structural information, that a user corresponding to the eye corresponds to a previous user; and
authenticating the user based on the determination that the user corresponds to the previous user.

13. The method of claim 12, wherein the reflected signal comprises a first frequency profile and a second frequency profile, further comprising:
determining the surface structural information based on the first frequency profile; and
determining the internal structural information based on the second frequency profile.

14. The method of claim 12, wherein the reflected signal comprises information about motion of the eye.

15. The method of claim 12, wherein said determining that the user corresponds to the previous user comprises performing:
generating one or more embeddings based on the reflected signal;
generating a similarity score between the one or more embeddings based on the reflected signal and one or more embeddings based on the previous user; and
determining the similarity score is above an authentication threshold.

16. A non-transitory computer-readable storage medium storing program instructions, wherein the program instructions, when executed on or across one or more processors, cause the one or more processors to:
receive information about a reflected signal from a frequency modulated continuous wave (FMCW) sensor, wherein the FMCW sensor is directed to an eye;
determine structural information of the eye based on the reflected signal, wherein the structural information comprises surface structural information and internal structural information;
determine, based on the structural information, that a user corresponding to the eye corresponds to a previous user; and
authenticate the user based on the determination that the user corresponds to the previous user.

17. The computer-readable storage media of claim 16, wherein the reflected signal comprises a first frequency profile and a second frequency profile, and wherein the program instructions, when executed on or across the one or more processors, further cause the one or more processors to:
determine the surface structural information based on the first frequency profile; and
determine the internal structural information based on the second frequency profile.

18. The computer-readable storage media of claim 16, wherein the program instructions, when executed on or across the one or more processors, further cause the one or more processors to:
control a liquid crystal polymer to direct a signal from the FMCW sensor to the eye, wherein said controlling the liquid crystal polymer comprises sending one or more electrical signals to the liquid crystal polymer.

19. The computer-readable storage media of claim 16, wherein the internal structural information comprises information about material properties of the internal ocular structures of the eye.

20. The computer-readable storage media of claim 16, wherein the program instructions, when executed on or across the one or more processors, further cause the one or more processors to:
determine, based on the surface structural information, a blink state of the eye.
